(19) United States
(12) Patent Application Publication
(10) Pub. No.: US 2021/0171410 A1
(43) Pub. Date: Jun. 10, 2021

(54) STRUCTURE MATERIAL, STRUCTURE, METHOD FOR MANUFACTURING STRUCTURE, SEAL STRUCTURAL MATERIAL, STRUCTURE, METHOD OF CONSTRUCTING STRUCTURE, COMPOSITION FOR SEALING, AND ION SUPPLYING MATERIAL

(71) Applicant: NATIONAL UNIVERSITY CORPORATION TOKAI NATIONAL HIGHER EDUCATION AND RESEARCH SYSTEM, Nagoya-shi, Aichi (JP)

(72) Inventors: Hidekazu YOSHIDA, Nagoya-shi, Aichi (JP); Ippei MARUYAMA, Nagoya-shi, Aichi (JP)

(21) Appl. No.: 17/270,297

(22) PCT Filed: Aug. 22, 2019
(86) PCT No.: PCT/JP2019/032771

§ 371 Date: Feb. 22, 2021

(30) Foreign Application Priority Data
Aug. 23, 2018 (JP) 2018-156019

(51) Int. Cl. C04B 41/50; C04B 41/48

(52) U.S. Cl. CPC C04B 41/501; C04B 2103/0014; C04B 41/5036; C04B 41/48

(57) ABSTRACT

A structural material includes a base material for forming a structure and an ion supplying source provided inside or on a surface of the base material, and the ion supplying source supplies at least one of a cation or an anion that constitutes a sparingly soluble salt having a water-solubility of no greater than a first value at a temperature of an environment where the base material is installed.

### TECHNICAL FIELD

The present disclosure relates to structural materials and relates in particular to a structural material for constructing a structure, a structure constructed of the structural material, a method of constructing the structure, a composition for sealing that can be used in the structure, and an ion supplying material that can be used in the structural material.

### BACKGROUND ART

A number of structures are constructed not only on the ground but also undersea or underground, for example. Some structures, such as tunnels or deep underground disposal caverns (or facilities) for radioactive waste, need to be constructed very deep in the underground. Bedrock in the ground inevitably has porosities (or pore spaces) and cracks therein, and groundwater flow-out through these pores and cracks. The deeper a hollow space is dug underground, the more challenging it becomes to avoid a sudden, unexpected flow-out of groundwater caused by a rise in the pore water pressure of the groundwater. Accordingly, techniques for shutting off groundwater for an extended period of time even under a high pore water pressure are indispensable in order to utilize underground environments or hollow spaces for an extended period of time. Moreover, the durability of structural materials constituting structures needs to be improved.

[patent document 1] JP4-1365

### Problem to be Solved by the Invention

In one conventional technique, as described in patent document 1, for example, an injection tube is inserted into an injection hole formed inside a crack, and with an outlet of that injection tube in contact with the crack, an injection agent for crack injection, such as a cement-based agent, that is highly permeable into the crack is injected. Then, the injection agent is allowed to harden to shut off the water.

Moreover, when an underground structure, such as a tunnel, is constructed, pore spaces (or voids) inevitably arise in a contact part (collectively referred to below as a “tunnel contact part”) present between the underground structure, such as a tunnel, and the ground owing to the concrete injected to form the upper surface being insufficient or the concrete shrinking as its hardens and dries. Therefore, the tunnel contact part is filled with a ground material such as cement or mortar to shut off the water or to provide reinforcement.

However, it has not been verified to a sufficient degree whether such shut-off of water or the durability of existing structures achieved through the conventional techniques can be retained for an extended period of several ten years or more. Accordingly, needs exist for the development of techniques that allow the strength or the durability of a water shut-off portion or a structural material to be maintained for an extended period of time.

The present disclosure has been made in view of the above and is directed to providing a technique for improving the durability of a structural material or a structure.

### Means to Solve the Problem

To address the technical challenge described above, a structural material according to one aspect of the present disclosure includes a base material for forming a structure and an ion supplying source provided inside or on a surface of the base material. The ion supplying source supplies at least one of a cation or an anion that constitutes a sparingly soluble salt having a water-solubility of no greater than a first value at a temperature of an environment where the base material is installed.

Another aspect of the present disclosure provides also a structural material. This structural material includes a base material for forming a structure and a surface layer formed on a surface of the base material. The surface layer includes a sparingly soluble salt having a water-solubility of no greater than a first value at a temperature of an environment where the base material is installed.

Yet another aspect of the present disclosure provides a structure. This structure includes a foundation and a framework in contact with the foundation. At least one of the foundation or the framework includes a structural material. The structural material includes a base material for forming a structure. A sparingly soluble salt having a water-solubility of no greater than a predetermined value at a temperature of an environment where the base material is installed is formed on a surface of the base material or in a pore space inside or around the base material.

Yet another aspect of the present disclosure provides a method of constructing a structure. This method is for constructing a structure of a structural material and includes installing a base material and providing an ion supplying source inside or on a surface of the base material.

Yet another aspect of the present disclosure provides a method of constructing a structure. This method is for constructing a structure of a structural material and includes installing a base material and forming a surface layer that includes a sparingly soluble salt on a surface of the base material.

Yet another aspect of the present disclosure provides a composition for sealing. This composition for sealing forms a surface layer on a surface of a base material for forming a structure or fills or closes off a pore space or a crack inside or outside the base material. The composition for sealing includes a cation or an anion that can constitute a sparingly soluble salt having a water-solubility of no greater than a predetermined value at a temperature of an environment where the composition for sealing is installed and an ion-exchange resin having adsorbed thereto at least one of the cation or the anion.

Yet another aspect of the present disclosure provides a composition for sealing. This composition for sealing forms a surface layer on a surface of a base material for forming a structure or fills or closes off a pore space or a crack inside or outside the base material. The composition for sealing includes a cation or an anion that can constitute a sparingly soluble salt having a water-solubility of no greater than a predetermined value at a temperature of an environment where the composition for sealing is installed and a counterion that can constitute, with the cation or the anion, a readily soluble salt having a water-solubility of greater than the predetermined value at a temperature of an environment where the composition for sealing is installed.

Yet another aspect of the present disclosure provides a composition for sealing. This composition for sealing forms a surface layer on a surface of a base material for forming a structure or fills or closes off a pore space or a crack inside or outside the base material. The composition for sealing includes a sparingly soluble salt having a water-solubility of no greater than a predetermined value at a temperature of an environment where the composition for sealing is installed.

Yet another aspect of the present disclosure provides an ion supplying material. This ion supplying material supplies at least one of a cation or an anion that constitutes a sparingly soluble salt having a water-solubility of no greater than a predetermined value at a temperature of an environment where the ion supplying material is installed.

### Advantage of the Present Invention

The present disclosure can help improve the durability of a structural material or a structure.

### BRIEF DESCRIPTION OF THE DRAWINGS

FIG. 1 is a formation rate diagram for estimating a formation rate of a concretion;

FIG. 2 schematically illustrates an example of a structure according to an embodiment;

FIG. 3 schematically illustrates an example of a structure according to an embodiment;

FIG. 4 schematically illustrates an example of a structure according to an embodiment;

FIG. 5 illustrates a result of an experiment conducted to form a sparingly soluble salt from a sample that models a structural material according to an embodiment;

FIG. 6 is a photograph of a thin slice of a sample captured by a polarizing microscope (transmitted light) one week after the start of an experiment;

FIG. 7 is a photograph of a thin section of a sample captured by a polarizing microscope (polarized light) one week after the start of an experiment;

FIG. 8 is a photograph of a thin section of a sample captured by a scanning electron microscope one week after the start of an experiment;

FIG. 9 is a photograph of a thin section of a sample captured by a scanning electron microscope one week after the start of an experiment; and

FIG. 10 illustrates a distribution of sizes of calcium carbonate crystals formed in a sample in one week after the start of an experiment.

### MODE FOR CARRYING OUT THE INVENTION

The present inventors are doing research on spherical masses called a concretion found in strata of sedimentary rocks. A concretion is a very hard, compact mass of calcium carbonate (CaCO₃) and often contains a fossil therein. Concretions are found also in strata that are as old as several ten thousand years to several ten million years. Yet, even in a case where the bedrock and the strata surrounding such concretions are weathered by exposure to natural environments for many years, the concretions very often retain their shapes without being weathered. It is now known that fossils inside concretions are preserved in a very good condition with little change in their quality even after several ten million years.

The research by the present inventors has revealed that a concretion is formed as follows. Specifically, a carbon component constituting the body composition of an organism contained in the form of a fossil inside the concretion seeps out through the mouth or the like of the organism in the form of bicarbonate ions (HCO₃⁻). The bicarbonate ions diffuse into the surrounding stratum due to the concentration gradient and react chemically with calcium ions present in the stratum. Then, the resultant is precipitated in the form of calcium carbonate having a low water-solubility. According to this mechanism, a carbon component constituting an organism's body seeps out in the form of bicarbonate ions and rapidly grows into a spherical mass around the organ of the body through which the bicarbonate ions seep out. This spherical mass forms quickly, around the organism, a chemically very stable, compact barrier that is not weathered even upon exposure to natural environments. Then, this barrier preserves the fossil of the organism therein in a very good condition for as long as more than several ten thousand years thereafter.

Applying this mechanism, the present inventors have come to think that forming a surface layer of a sparingly soluble salt, such as calcium carbonate, on an outer surface of a base material, such as cement or concrete, for forming a structure can keep the structural material from deteriorating and can drastically improve the strength and the durability of a structure.

In other words, a structural material according to an embodiment of the present disclosure includes a base material for forming a structure and an ion supplying source provided inside or on a surface of the base material. The ion supplying source supplies at least one of a cation or an anion that constitutes a sparingly soluble salt having a water-solubility of no greater than a first value at a temperature of an environment where the base material is installed.

There is no concrete structure that is in existence for more than several thousand years since its construction. Therefore, no one knows whether concrete structures constructed to date can endure for an extended period of time henceforth. However, the existence of concretions proves that a surface layer formed of calcium carbonate has the durability that can keep the surface layer from changing in quality even when it has been exposed continuously to natural environments for an extended period of time of more than several thousand years. It is expected that a structure that can endure semi-permanently can be constructed by covering a structural material with a surface layer of calcium carbonate or the like formed through the mechanism similar to that of concretions.

The sparingly soluble salt is, for example, calcium carbonate, and the ion supplying source supplies, for example, calcium ions. In this case, although the process is the reverse of the process in which a concretion is produced, the calcium ions supplied from the ion supplying source diffuse onto the surface of the base material or into pore spaces inside the base material by the medium of water or the like present around the base material or in the pore spaces inside the base material. Then, the calcium ions react chemically with bicarbonate ions or carbonate ions (CO₃²⁻) present around the base material to precipitate calcium carbonate. This process makes it possible to cover the surface of the structural material or the pore spaces inside the structural material with a surface layer formed of the sparingly soluble salt, such as calcium carbonate, as in the case of a concretion. The surface layer can then keep the structural material from changing in chemical quality by keeping moisture surrounding the structural material or substances such as acids, bases, oxidants, or reducing agents dissolved in the moisture from entering the structural material. The surface layer can also keep the structural material from deteriorating despite any environmental conditions such as a change in the temperature. Moreover, the surface layer can keep the strength of the base material from decreasing by keeping the components constituting the base material from seeping out of the base material. This can help improve the durability of the structural material. Furthermore, the surface of the structural material can be covered with the surface layer of the hard, sparingly soluble salt, and the pore spaces inside the structural material can be filled with the sparingly soluble salt. This can help improve the strength of the structural material. As in the process in which a concretion is produced, bicarbonate ions may be supplied from the ion supplying source, and the bicarbonate ions may be allowed to react chemically with calcium ions surrounding the structural material to precipitate calcium carbonate.

The sparingly soluble salt may be any sparingly soluble salt that has a sufficiently low water-solubility at a temperature of an environment where the structural material is installed, that is chemically stable, and that does not contaminate the surrounding natural environments. Examples include carbonates, such as calcium carbonate, magnesium carbonate, and iron(II) carbonate (siderite); double salts, such as calcium magnesium carbonate (CaMg(CO₃)₂, dolomite); and sulfates, such as calcium sulfate. Although it depends on the crystal structure and so on, the solubility of calcium carbonate is about 0.0015 [g/100 g water] at 20° C., the solubility of magnesium carbonate is 0.039 [g/100 g water] at 20° C., the solubility of iron(II) carbonate is 0.00006554 [g/100 g water] at 20° C., and the solubility of calcium sulfate is 0.24 [g/100 g water] at 20° C. Therefore, as the solubility in 100 g of water at 20° C., the first value may be, for example, 0.3, more preferably 0.04, or even more preferably 0.002. It suffices that the solubility of the sparingly soluble salt be lower than the solubility of a compound that is a main component of the base material. In other words, the first value may be the value of the solubility of the compound, such as calcium hydroxide or calcium sulfate, that is a main component of the base material described later.

The sparingly soluble salt may be selected as appropriate in accordance with the environment where the structural material is installed. For example, upon chemical reaction with carbon dioxide, calcium carbonate can turn into calcium hydrogencarbonate having a relatively high water-solubility. Therefore, in a case where the structural material is to be installed in an environment where the concentration of carbon dioxide is relatively high, the structural material may contain an ion supplying source supplying ions that form a sparingly soluble salt other than calcium carbonate. Moreover, calcium carbonate can dissolve upon chemical reaction with an acid. Therefore, in a case where the structural material is to be installed in an environment where the pH is relatively low, the structural material may contain an ion supplying source supplying ions, such as iron(III) ions, of which hydroxides are sparingly soluble in water. Thus, even if an acid present in the surroundings of the structural material causes calcium carbonate on the surface of, inside, or around the structural material to dissolve, this calcium carbonate neutralizes the acid to raise the pH, and a sparingly soluble hydroxide is precipitated. Accordingly, the surface of the structural material can be covered with the precipitated hydroxide, or a pore space inside or around the structural material can be filled with the precipitated hydroxide. Examples of ions for forming a sparingly soluble hydroxide may include an iron(III) ion, an aluminum ion, a copper(II) ion, a zinc ion, and a manganese ion.

In a case where the structural material is to be installed underground or on the seabed, for example, the ions supplied from the ion supplying source diffuse out of the structural material through its surface by the medium of, for example, the groundwater gushing in the stratum, the bedrock, or the like surrounding the structural material or the seawater surrounding the structural material. Thus, as in the case of a concretion, the surface layer of a sparingly soluble salt formed on the surface of the structural material grows outward from the structural material to increase its thickness. This can help further improve the durability and the strength of the structural material.

At this time, these ions diffuse also into pore spaces, cracks, and so on present in the bedrock or the stratum surrounding the structural material. Therefore, a sparingly soluble salt is formed in the pore spaces and the cracks as well. Thus, the cracks, the pore spaces, and so on present in the bedrock or the like surrounding the structural material can be closed off by the sparingly soluble salt. This can help improve the strength of the bedrock surrounding the structural material and can also keep the groundwater, the seawater, or the like gushing out through the cracks and so on in the bedrock surrounding the structural material from entering the structural material. The ions supplied from the ion supplying source diffuse in accordance with the concentration gradient of the ions. Typically, the concentration of the ions present originally in the surroundings of the structural material is low, and this allows the ions to diffuse easily into the pore spaces and the cracks in the bedrock surrounding the structural material without any external force or the like being applied to the ions. Moreover, the ions diffuse while the ions are dissolved in water. Therefore, the ions can diffuse easily even into atomic or molecular level, micro-pores, cracks, and so on irrespective of the pore water pressure even at a deep underground site, and the ions can form a sparingly soluble salt to close off the pore spaces and the cracks. This makes it possible to shut off the water in the surroundings of the structural material more reliably. Such reliable, long-lasting shut-off of the groundwater entering from the bedrocks is something that the conventional technique described above is unable to achieve. Moreover, since the amount of a sparingly soluble salt to be precipitated is determined in accordance with the concentration of cations and anions and the solubility product of the sparingly soluble salt, no excess amount of the sparingly soluble salt is precipitated. Accordingly, the above-described technique can overcome the technical problem faced by the conventional technique of closing off a pore space by injecting a filler into the pore space, that is, the technical problem that an excess amount of filler is injected to crush the structural material or its bedrock or the like, possibly causing a crack or damage.

The amount in which or the rate at which the ions supplied from the ion supplying source diffuse out of the structural material through its surface is determined in accordance with, for example, the diffusion coefficient of the ions in the surroundings of the structural material, the solubility of the sparingly soluble salt into the water at the temperature of the environment where the structural material is installed, or the amount of the ions supplied from the ion supplying source or the rate at which the ions are supplied from the ion supplying source. Therefore, the amount of the ions supplied from the ion supplying source or the rate at which the ions are supplied from the ion supplying source may be selected as appropriate in accordance with the diffusion coefficient of the ions in the surroundings of the structural material and the solubility of the sparingly soluble salt into the water at the temperature of the environment where the structural material is installed. This makes it possible to control, for example, the thickness of the surface layer formed of the sparingly soluble salt on the surface of the structural material or the range of the pore space or the crack around the structural material to be closed off by the sparingly soluble salt.

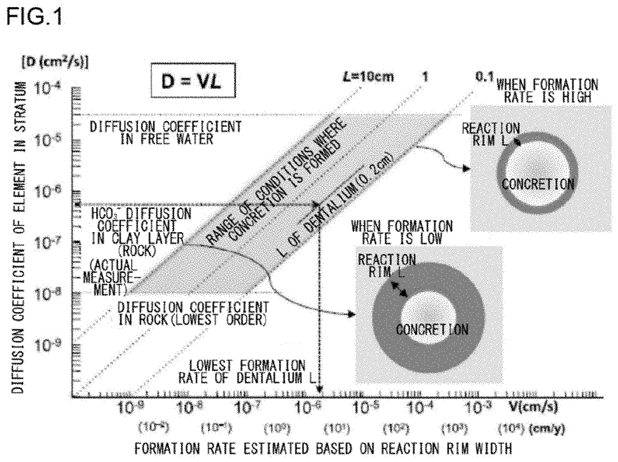

FIG. 1 is a formation rate diagram for estimating the formation rate of a concretion. FIG. 1 illustrates a diagram for estimating the formation rate of a concretion formed of an organism called a tusk-shell, and the formation rate is estimated based on the width of the reaction rim of the concretion. The vertical axis indicates the diffusion rate of bicarbonate ions, and the horizontal axis indicates the reaction rate associated with the precipitation of calcium carbonate resulting from the reaction of bicarbonate ions with calcium ions. When the diffusion rate of bicarbonate ions is too low, a compact layer of calcium carbonate is formed in an early stage around the tusk-shell, and this layer keeps the bicarbonate ions from diffusing further to the outer side. This results in a thin reaction rim. In contrast, when the diffusion rate of bicarbonate ions is too high, the bicarbonate ions diffuse further to the outer side before a concretion grows as calcium carbonate is precipitated. This allows the concretion to grow only to a certain thickness. Accordingly, supplying an appropriate amount of ions at an appropriate rate in accordance with the diffusion coefficient of the ions in the environment surrounding the structural material makes it possible to form a surface layer having a desired thickness.

The thickness of the surface layer to be formed on the surface of the structural material may be determined in accordance with, for example, the depth of the position where the structural material is installed, the strength and the components of the bedrock surrounding the structural material, the amount of the groundwater surrounding the structural material, and/or the components and the quantity of chemical substances dissolved in the groundwater surrounding the structural material. The type of the ion supplying source, the amount of ions that can be supplied, the position at which and the manner in which the ion supplying source is installed, and so on are designed such that the ions are supplied in an amount and at a supply rate that allow a surface layer having the determined thickness to be formed.

The ion supplying source may include an ion-exchange resin having adsorbed thereto the ions to be supplied. In this case, an ion-exchange resin that releases ions in an appropriate amount and at an appropriate supply rate can be selected or designed in accordance with, for example, the type of the ions to be supplied and/or the components, the amount, or the pH of the chemical substances dissolved in the groundwater surrounding the structural material.

The ion supplying source may include a capsule that encapsulates and releases gradually the ions to be supplied. The ions to be encapsulated in the capsule may be contained in the form of a readily soluble salt having a water-solubility of greater than a first value at the temperature of the environment where the structural material is to be installed or in the form of an ion-exchange resin having adsorbed thereto the ions. For example, in the case of an ion supplying source that supplies calcium ions, the readily soluble salt may be, for example but not limited to, calcium chloride (CaCl₂) having a water-solubility of 74.5 [g/100 g water] at 20° C., calcium nitrate (Ca(NO₃)₂) having the water-solubility of 121.2 [g/100 g water], or calcium hydrogencarbonate (Ca(HCO₃)₂) having the water-solubility of 16.6 [g/100 g water]. In this case as well, the material, the thickness, the shape, or the like of the capsule that releases the ions in an appropriate amount and at an appropriate supply rate can be selected or designed in accordance with, for example, the type of the ions to be supplied and/or the components, the amount, or the pH of the chemical substances dissolved in the groundwater surrounding the structural material. In a case where the ion supplying source includes a capsule, the capsule may be embedded in the structural material. For example, the capsule may be compounded in advance into the cement or the concrete that is to serve as the base material of the structural material.

The ion supplying source may include a sheet that contains the ions to be supplied. The ions to be contained in the sheet may be contained in the form of a readily soluble salt having a water-solubility of greater than a first value at the temperature of the environment where the structural material is to be installed or in the form of an ion-exchange resin having adsorbed thereto the ions. In this case as well, the material, the thickness, the shape, or the like of the sheet that releases the ions in an appropriate amount and at an appropriate supply rate can be selected or designed in accordance with, for example, the type of the ions to be supplied and/or the components, the amount, or the pH of the chemical substances dissolved in the groundwater surrounding the structural material. In a case where the ion supplying source includes a sheet, the sheet may be affixed to, for example, the surface of the structural material or the bedrock or the stratum on which the structural material is installed.

The ion supplying source is installed inside or around the structural material in an amount or at a distribution that allows the ion supplying source to release the ions in an appropriate amount and at an appropriate supply rate in accordance with, for example, the type of the ions to be supplied and/or the components, the amount, the pH or the like of the chemical substances dissolved in the groundwater surrounding the structural material. In order to determine the type of the ions to be supplied, information is acquired concerning the constitution of any substance or any mineral that exists presently or that is expected to exist in the future at or around the location where the base material is to be installed, when a structure is constructed of the structural material. The ion supplying source is provided in the type or the amount corresponding to the constitution of the substance or the mineral that exists presently or that is expected to exist in the future at or around the location where the base material is to be installed. For example, as described above, the ion supplying source may supply cations that form a sparingly soluble hydroxide in accordance with the pH of the surroundings. Moreover, a pH regulator, such as phosphoric acid, may be added. In a case where the ions of the type to be supplied are present in the surroundings, the ion supplying source does not need to supply the entire amount of the ions to be supplied. Therefore, the amount of the ions to be supplied may be reduced in accordance with the amount of the ions present in the surroundings. This can help reduce the cost of the structural material even in a case where a large-scale structure is to be constructed.

In a relatively short period after the structural material has been installed, the ions supplied from the ion supplying source diffuse into the structural material, onto the surface of the structural material, and to the outside of the structural material by the medium of water, and a surface layer of a sparingly soluble salt is formed on the surface of the structural material. The water that serves as the medium for diffusing the ions is, for example, the groundwater that gushes out in the surroundings of the structural material in a case where the structural material is installed underground, the water such as seawater in a case where the structural material is installed underwater such as undersea, the rainwater or the moisture in the air in a case where the structural material is installed outdoors, or the moisture in the air in a case where the structural material is installed indoors. Once a surface layer having a sufficient thickness is formed on the surface of the structural material, the surface layer can thereafter keep the moisture or the like from entering the structural material. This can help keep the inside of the structural material from deteriorating.

Even if a pore space or a crack arises in the surface layer or inside the structural material due to, for example, an external force caused by an earthquake, tectonics, a tide, a typhoon, or the like after the surface layer has been formed, the ions supplied from the ion supplying source diffuse into the pore space or the crack in the surface layer or inside the structural material as long as the ions to be supplied remain in the ion supplying source included in the structural material. Therefore, the pore space or the crack can be filled with or closed off by the sparingly soluble salt precipitated through the reaction of of the supplied ions with counterions. In this manner, the technique according to the present embodiment can provide a self-repairing (self-sealing) function to the structural material, and this can help further improve the durability of the structural material. It is desirable that the ion supplying source be designed such that the ions to be supplied remain in the ion supplying source even after the surface layer has been formed on the structural material. In addition to the ion supplying source designed to supply ions necessary for forming the surface layer on the surface of the structural material immediately after the structural material has been installed, another ion supplying source may be installed near the surface layer. In this other ion supplying source, a readily soluble salt including ions, an ion-exchange resin, or the like may be contained in a container, such as a capsule, that breaks by an external force and releases its contents upon the structural material receiving the external force that can cause damage, such as a pore space or a crack, to the surface layer.

In a case where the structural material is to be installed in an environment, such as outdoors or indoors, where counterions for producing a sparingly soluble salt are scarcely present in the surroundings, a first ion supplying source that supplies cations that constitute a sparingly soluble salt and a second ion supplying source that supplies anions serving as counterions may be contained in the structural material and installed inside or around the structural material. In this case as well, the type of the ion supplying source, the amount of the ions that can be supplied, the position at which and the manner in which the ion supplying source is installed, and so on are designed such that the ions are supplied in an amount and at a supply rate that allow a surface layer having a desired thickness to be formed on the surface of the structural material. The position at which, the amount in which, or the distribution with which the first ion supplying source and the second ion supplying source are installed may be designed such that the concentration of the cations supplied from the first ion supplying source and the concentration of the anions supplied from the second ion supplying source exceed the solubility product at the position where the surface layer is to be formed.

The base material of the structural material may be composed of cations or anions of the same type as the cations or the anions that constitute a sparingly soluble salt and may include a sparingly soluble compound having a water-solubility of no greater than a second value greater than the first value at the temperature of the environment where the structural material is to be installed. In this case, the ion supplying source is configured to supply ions that are common between the sparingly soluble salt and the sparingly soluble compound. For example, the sparingly soluble salt and the sparingly soluble compound may be a sparingly soluble salt of calcium. More specifically, the sparingly soluble salt may be calcium carbonate, and the sparingly soluble compound may be calcium hydroxide or calcium sulfate, which is a main component of cement, concrete, or the like. Then, even if groundwater, rainwater, or the like enters the structural material, such as concrete, the calcium ions supplied from the ion supplying source can shift the solution equilibrium of the sparingly soluble compound inside the structural material to the solid side, and this can keep the calcium ions from being eluted from the base material. Accordingly, the calcium ions constituting the base material can be kept from seeping out gradually, and any small pores or cracks that could reduce the strength of the structural material can be kept from being formed inside the base material. This can therefore help retain the strength of the structural material for an extended period of time and in turn can help improve tremendously the durability of the structural material.

The water-solubility of calcium hydroxide at 20° C. is 0.173 [g/100 g water], and the water-solubility of calcium sulfate at 20° C. is 0.24 [g/100 g water]. Therefore, the second value is, for example, 1, preferably 0.5, more preferably 0.25, or even more preferably 0.2. It suffices that the solubility of the sparingly soluble compound be lower than the solubility of the readily soluble salt included in the ion supplying source. In other words, the second value may be the value of the solubility of the readily soluble salt described above. The first value and the second value indicate the relationship between the solubilities of the sparingly soluble salt and the sparingly soluble compound included in one structural material. In other words, it suffices that the solubility of the sparingly soluble salt formed from the ions supplied from the ion supplying source included in a given structural material be lower than the solubility of the sparingly soluble compound included in the base material of that structural material. For example, in a case where gypsum containing calcium sulfate as its main component is used as the base material, calcium carbonate or the like having a lower solubility than calcium sulfate is selected as the sparingly soluble salt. Meanwhile, in a case where a compound having a higher solubility than calcium sulfate is used as the base material, calcium sulfate may be selected as the sparingly soluble salt.

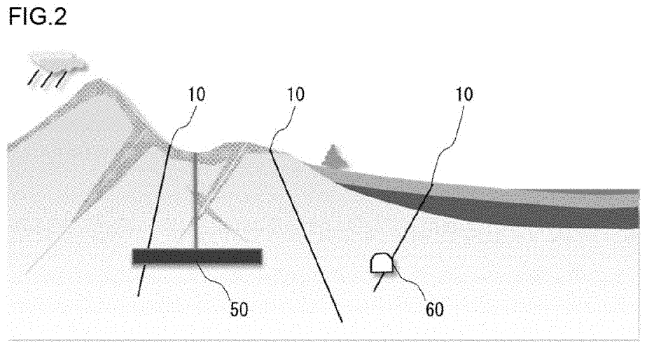

FIG. 2 schematically illustrates an example of a structure according to the embodiment. When an underground disposal plant 50 for, for example, industrial waste or radioactive waste is constructed by use of the technique according to the present disclosure, the outer wall of the underground disposal facility 50 can be closed off reliably, and thus any toxic substances or radioactive substances can be kept from leaking outside the underground disposal plant 50 for an extended period of time. Moreover, when an underground structure, such as a tunnel 60, is constructed by use of the technique according to the present disclosure, the outer wall of the underground structure can be closed off reliably, and any pore space in a tunnel contact part between the underground structure and the ground can be filled. Therefore, the water can be shut off for an extended period of time, and the strength and the durability of the underground structure can be improved. Furthermore, when a boring hole 10 drilled when the underground disposal plant 50 or the tunnel 60 is constructed is sealed by use of the technique according to the present disclosure, the boring hole 10 can be kept being closed off for an extended period of time.

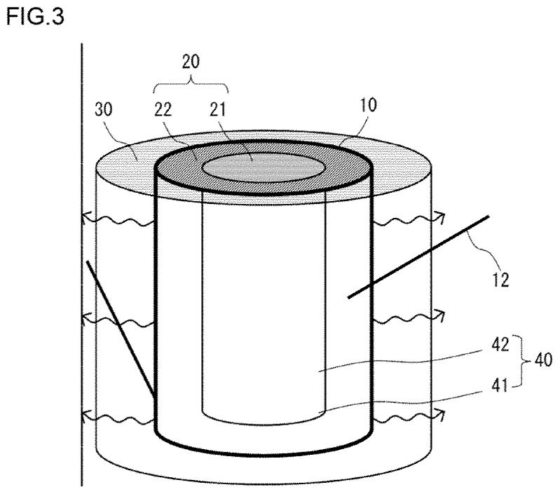

FIG. 3 schematically illustrates an example of a structure according to the embodiment. A structure 40 illustrated in FIG. 3 is for closing off a boring hole 10 drilled in the ground. The structure 40 includes a foundation 41 in contact with the ground and a rod-shaped framework 42 in contact with the foundation 41. The foundation 41 and the framework 42 are formed of a structural material 20 according to the present disclosure. When an underground facility, such as the underground disposal plant 50, or an underground structure, such as the tunnel 60, is to be constructed, a plurality of boring holes 10 are drilled in order to investigate, for example, the geological features of the underground site or the amount of the groundwater. Conventionally, the boring holes 10 are closed off by cement or the like injected into the boring holes 10. However, this method cannot close off the boring holes 10 completely, or the boring holes 10 may serve as flow-paths for groundwater or the like if the cement or the like deteriorates over time and many cracks and pore spaces arise in the cement or the like. When a radioactive waste disposal facility or the like is constructed underground, even a micro-pore can allow radioactive rays and radioactive substances to leak therethrough. Therefore, the boring holes 10 need to be closed off more reliably for an extended period of time. When each boring hole 10 is closed off by the structural material 20 according to the present embodiment that includes a base material 21, such as cement, and an ion supplying source 22, the ions supplied from the ion supplying source 22 diffuse into a tiny crack 12 or a pore space around the boring hole 10 and form a sparingly soluble salt 30 upon chemical reaction with counterions present in the surroundings. Therefore, the boring hole 10 can be closed off more reliably. Moreover, even if the cement or the like serving as the base material 21 deteriorates over time and a crack or a pore space arises in the cement, the ions supplied from the ion supplying source 22 diffuse into the crack or the pore space and form a sparingly soluble salt upon chemical reaction with counterions. Therefore, the crack or the pore space that has arisen can be closed off, and the boring hole 10 can be kept being closed off for an extended period of time.

Before the base material 21, such as cement, is injected into the boring hole 10, a sheet-like ion supplying source 22 may be affixed to a wall surface of the boring hole 10. Then, the base material 21, such as cement, may be injected into the boring hole 10. Before the base material 21 is injected into the boring hole 10, a liquid containing an ion supplying source 22 in the form of an ion-exchange resin or a capsule may be injected into the boring hole 10, and the wall surface of the boring hole 10 may be coated with the ion supplying source 22. Then, the base material 21, such as cement, may be injected into the boring hole 10. Before the base material 21 is injected into the boring hole 10, an ion supplying source 22 in the form of an ion-exchange resin or a capsule may be compounded with the base material 21. Then, the structural material 20 that includes the ion supplying source 22 and the base material 21 may be injected into the boring hole 10. Fillers such as crushed silica, alumina, sand, or surrounding bedrock may further be compounded into the base material 21. This can help lower the cost of construction and protect the sealing of the structural material or the sparingly soluble salt from acids to improve the durability.

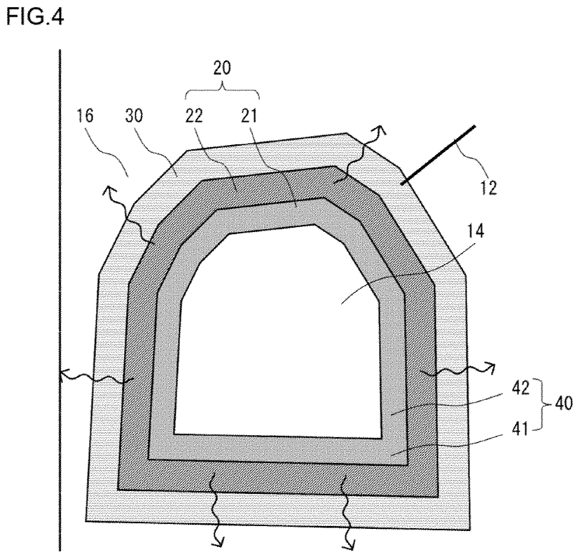

FIG. 4 schematically illustrates an example of a structure according to the embodiment. A structure 40 illustrated in FIG. 4 constitutes a wall that separates a hollow space formed underground, a facility such as the underground disposal facility 50, or a space 14 such as the tunnel 60 from its surrounding bedrock 16. The structure 40 includes a foundation 41 installed on and in contact with the ground and a tunnel-like framework 42 formed on and in contact with the foundation 41. The framework 42 includes a wall erected on the foundation 41 and a roof body provided over the wall. The foundation 41 and the framework 42 are formed of a structural material 20 according to the present disclosure. In the example illustrated in FIG. 4, a sheet-like ion supplying source 22 is affixed to an outer side of the wall formed of a base material 21, such as concrete. Thus, the ions diffuse into the outer bedrock 16 from the sheet of the ion supplying source 22, and a crack 12 in the bedrock 16 or any pore space in a tunnel contact part between the foundation 41 and the bedrock 16 can be closed off by a sparingly soluble salt 30. This can help improve the strength of the bedrock 16 and keep the groundwater or the like from gushing out. Moreover, the ions diffuse into the inner base material 21 from the sheet of the ion supplying source 22, and a surface layer of a sparingly soluble salt can be formed on the surface of the base material 21. This can help improve the strength and the durability of the structural material 20.

Before the base material 21, such as concrete, is installed on the wall surface, a sheet-like ion supplying source 22 may be affixed to the bedrock 16 surrounding the space 14, such as a tunnel. Then, the base material 21 may be installed on the inner side of the sheet. Before the base material 21 is installed, a liquid including an ion supplying source 22 in the form of an ion-exchange resin or a capsule may be applied or sprayed to the bedrock 16 surrounding the tunnel to form a coat of the ion supplying source 22. Then, the base material 21 may be installed on the inner side of that coat. Before the base material 21 is installed, an ion supplying source 22 in the form of an ion-exchange resin or a capsule may be compounded with the base material 21. Then, the structural material 20 that includes the ion supplying source 22 and the base material 21 may be installed on the bedrock 16 surrounding the tunnel. Fillers such as crushed silica, alumina, sand, or surrounding bedrock may further be compounded into the base material 21. This can help lower the cost of construction and protect the sealing of the structural material or the sparingly soluble salt from acids to improve the durability.

The structure according to the embodiment may be installed underwater or outdoors. In this case, no stratum or bedrock is present outside the structural material, and water or the air is present outside the structural material. In a case where the structure is installed undersea, it suffices that the ions that can form a sparingly soluble salt with the ions contained in the seawater be supplied by the ion supplying source. In contrast, in a case where the structure is installed outdoors, the air or the rainwater may not contain ions in an amount sufficient to form a surface layer of a sparingly soluble salt. Moreover, in a case where the structure is installed underground, a similar issue may arise if the amount of groundwater present in the surroundings is too little. In such cases, as described above, a first ion supplying source supplying cations that constitute a sparingly soluble salt and a second ion supplying source supplying anions may be installed. The ion supplying sources may each be formed into a sheet, and the two sheets may be placed on top of each other and affixed to the surface of the structural material. Alternatively, one of the ion supplying sources may be formed into a sheet, and the other ion supplying source may be contained within the sheet in the form of a capsule or the like.

The structural material according to the embodiment may be a base material having a surface layer of a sparingly soluble salt formed on its surface. In this case, the sparingly soluble salt may be formed of the ions supplied from the ion supplying source contained in the structural material. Alternatively, the sparingly soluble salt may be formed as the surface of the structural material or the surface of the bedrock or the stratum where the structural material is installed is coated or sprayed with a first liquid including cations that constitute the sparingly soluble salt and a second liquid including anions that constitute the sparingly soluble salt. The latter case makes it possible to manufacture the structural material of which the surface is protected by the surface layer of the sparingly soluble salt through a simpler method and to construct a structure of the structural material of which the surface is protected by the surface layer of the sparingly soluble salt through a simpler process. In this case, the ion supplying source may or may not be contained in the structural material. If the ion supplying source is contained in the structural material, the strength of the structural material can be improved by filling any pore space or crack inside the structural material with the sparingly soluble salt, and the durability of the structural material can be improved through its self-repairing function.

A composition for sealing can be used to form a surface layer on a surface of a base material for forming a structure of a structural material according to the embodiment or to fill or close off a pore space or a crack inside or outside the base material. The composition for sealing includes a cation or an anion that can constitute a sparingly soluble salt having a water-solubility of no greater than a predetermined value at a temperature of an environment where the composition for sealing is installed and an ion-exchange resin having adsorbed thereto the cation or the anion. This composition for sealing is used to form a structural material that contains an ion supplying source in the form of an ion-exchange resin.

A composition for sealing according to another aspect includes a cation or an anion that can constitute a sparingly soluble salt having a water-solubility of no greater than a predetermined value at a temperature of an environment where the composition for sealing is installed and a counterion that can constitute, with the cation or the anion, a readily soluble salt having a water-solubility of greater than the predetermined value at a temperature of an environment where the composition for sealing is installed. This composition for sealing is used for forming a structural material that contains an ion supplying source in the form of a capsule or a sheet or to coat or spray the structural material with the composition for sealing in order to form a surface layer of a sparingly soluble salt on the surface of the structural material.

A composition for sealing according to yet another aspect includes a sparingly soluble salt having a water-solubility of no greater than a predetermined value at a temperature of an environment where the composition for sealing is installed. This composition for sealing is used to form a surface layer on the surface of the structural material to seal the surface of the structural material.

An ion supplying material can be used to manufacture the structural material according to the embodiment. This ion supplying material supplies at least one of a cation or an anion that constitutes a sparingly soluble salt having a water-solubility of no greater than a predetermined value at a temperature of an environment where the ion supplying material is installed. This ion supplying material includes an ion-exchange resin including at least one of a cation or an anion that constitutes a sparingly soluble salt, a capsule that encapsulates the ion-exchange resin or a readily soluble salt including one of a cation or an anion and having a water-solubility of greater than a predetermined value at a temperature of an environment where the ion supplying material is installed, or a sheet including the readily soluble salt or the ion-exchange resin. This ion supplying material is used to manufacture a structural material that includes an ion supplying source in the form of an ion-exchange resin, a capsule, or a sheet.

The technique according to the present embodiment can be applied to improve the strength and the durability of an existing structure. A sheet of an ion supplying source may be affixed to the surface of a structural material constituting an existing structure, or a liquid containing an ion supplying source may be injected into a structural material. Thus, a pore space, a crack, or the like present inside or around the structural material forming the existing structure can be closed off, and the structural material constituting the existing structure can be provided with a self-repairing function. This can help improve the strength and the durability of the structure. Moreover, the surface of the existing structure may be coated or sprayed with a first liquid including a cation that constitutes a sparingly soluble salt and a second liquid including an anion. Thus, a surface layer of the sparingly soluble salt can be formed on the surface of the existing structure, and this can help improve the strength and the durability of the structure.

The technique according to the present embodiment can be applied to bond structural materials to each other. A sheet of an ion supplying source may be affixed to the bonding surface of one or both structural materials, a liquid that includes an ion supplying source may be applied to the bonding surface of one or both structural materials, or an ion supplying source may be incorporated in advance into one or both the structural materials. Then, the bonding surfaces of the structural materials may be tightly bonded to each other. Thus, the ions supplied from the ion supplying source diffuse onto the bonding surfaces, and the void between the structural materials can be filled with a sparingly soluble salt. This makes it possible bond a plurality of structural materials to air-tightly or liquid-tightly with a sparingly soluble salt. An ion supplying source may be injected into the bonding surface of each structural material. For example, an ion supplying source may be injected into a bonding surface of a structural material constituting an existing structure or into a tunnel contact part between the ground and an existing underground structure, such as a tunnel 60. This can help improve the tightness of bonding at the bonding surfaces or the tunnel contact part and improve the strength and the durability of the structure.

### Example

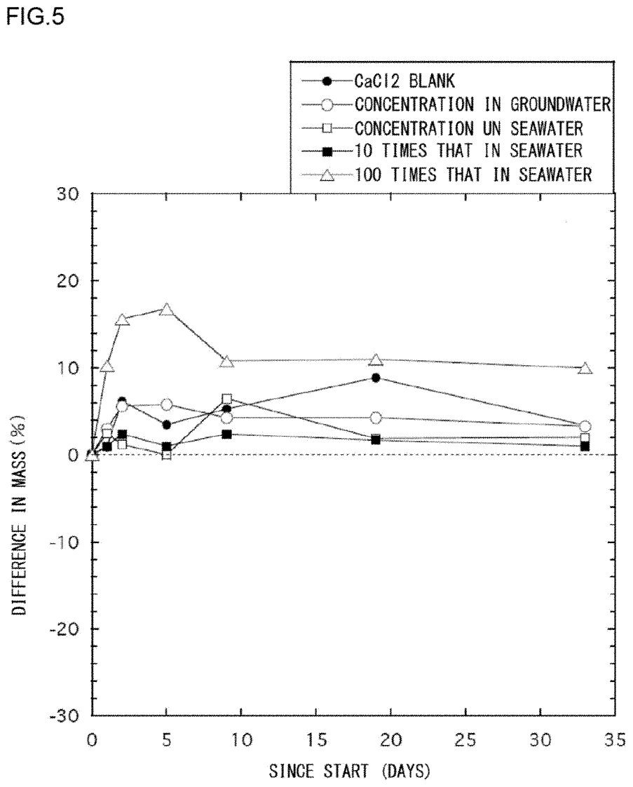

FIG. 5 illustrates a result of an experiment conducted to form a sparingly soluble salt from a sample that models the structural material according to the embodiment. About 1 g of agar and about 9 g of sodium hydrogencarbonate (NaHCO₃) were added to 100 g of water and dissolved by heat. Then, the solution was cooled to solidify to produce a cubic sample that measured about 1 cm on each side. The solubility of sodium hydrogencarbonate is 9.6 g in 100 g of water at 20° C. Therefore, the produced sample contained the amount of sodium hydrogencarbonate substantially at saturation at room temperature. This sample was impregnated with an aqueous solution that contained calcium ions at substantially the same concentration as groundwater, an aqueous solution that contained calcium ions at substantially the same concentration as seawater, an aqueous solution that contained calcium ions at 10 times the concentration in seawater, an aqueous solution that contained calcium ions at 100 times the concentration in seawater, or a calcium chloride aqueous solution serving as a control experiment, and any change over time in the mass was measured. The result is shown in FIG. 5.

The samples all increased in mass by several percent to ten and several percent in several days since the start of the experiment, and these masses remained constant with no substantial change after the point when 10 days had passed since the start of the experiment. Moreover, the samples all became generally opaque and became harder in several days since the start of the experiment. This result confirmed that, in every sample, the calcium ions contained in the solution surrounding the sample diffused into the sample, precipitation of calcium carbonate was formed within several days from the start of the experiment, and further impregnation of the solution into the sample was suppressed thereafter to keep the mass of the sample unchanged. It was confirmed that precipitation of calcium carbonate was formed not only from an aqueous solution that had a high concentration of calcium ions but also from an aqueous solution that had substantially the same concentration of calcium ions as groundwater or seawater. Therefore, it was confirmed that, when the structural material according to the embodiment was installed in an environment where groundwater or seawater surrounds the structural material, precipitation of calcium carbonate could be formed in a short period of time to fill a pore space or a crack or to form a surface layer.

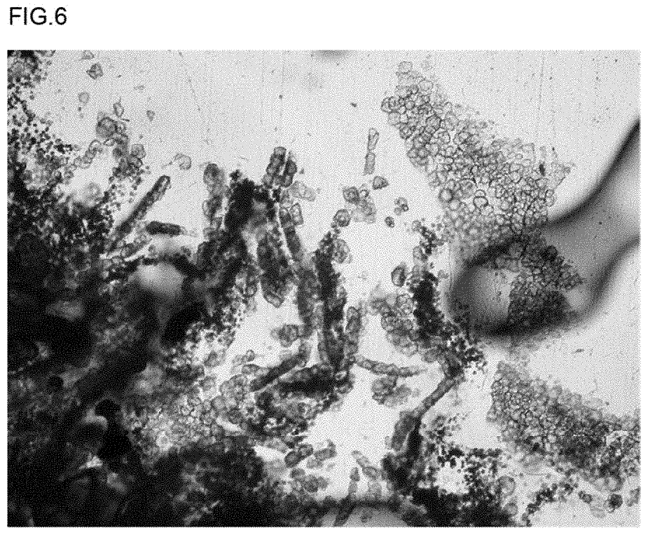

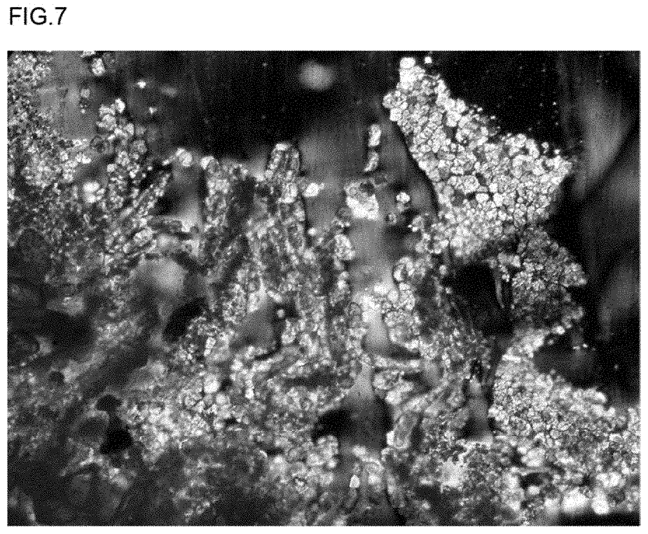

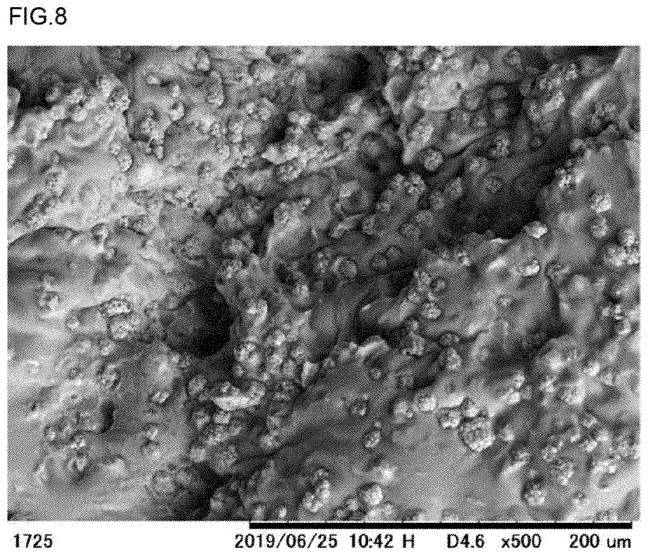

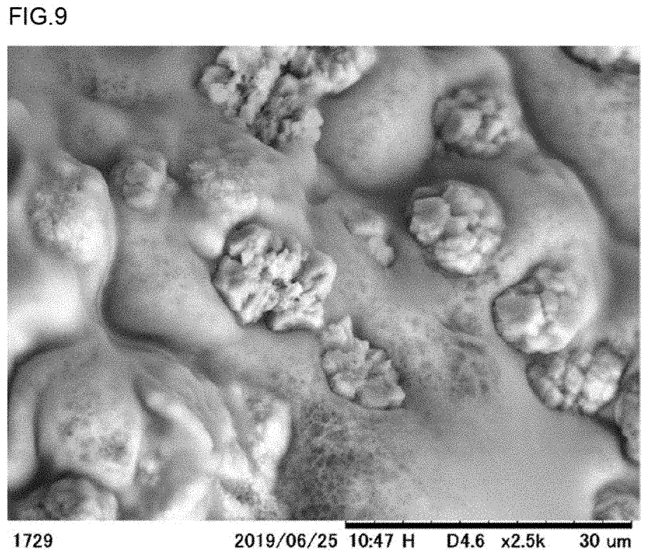

FIGS. 6 and 7 are each a photograph of a thin slice of a sample captured by a polarizing microscope one week after the start of the experiment. The image is about 0.5 mm wide. FIGS. 8 and 9 are each a photograph of a thin slice of a sample captured by a scanning electron microscope one week after the start of the experiment. The growth of aggregates of calcium carbonate crystals of several micrometers to several tens of micrometers was confirmed.

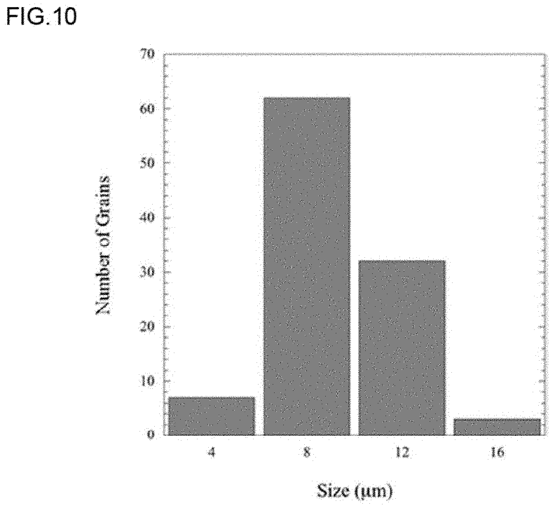

FIG. 10 illustrates a distribution of the sizes of the calcium carbonate crystals formed in a sample in one week after the start of the experiment. The sizes of calcium carbonate formed in the sample were very uniform, and in particular, about 90% of the total crystal grains had a diameter of 8 μm to 12 μm. A phenomenon where aggregates of calcium carbonate crystals having such a uniform grain size grow and are formed into a site deep inside a medium is not observed in nature. In nature, other substances such as sand or mud are inevitable get mixed in, and an aggregate of calcium carbonate crystals alone with a uniform, tiny grain size does not exist. Moreover, a phenomenon where aggregates of artificial calcium carbonate crystals alone culminate like a bunch of grapes is not observed in nature.

The calcium carbonate crystals in the medium grew continuously along with the passage of time, and their size reached up to several hundred micrometers in several weeks. It was confirmed that, as the calcium carbonate crystals grew, the distribution density of the calcium carbonate crystals in the medium increased and the dynamic strength of the medium also improved.

Thus far, the present disclosure has been described based on the example. This example is illustrative in nature, and it should be appreciated by a person skilled in the art that various modifications can be made to the combinations of the components and the processing processes described above and such modifications also fall within the scope of the present disclosure.

In the foregoing embodiment, the surface layer on the surface of the structural material is formed of a sparingly soluble salt. Alternatively, the surface layer on the surface of the structural material may be formed of a sparingly soluble compound other than a salt. In this case, a compound that itself is readily soluble in water and that causes precipitation of a sparingly soluble substance upon chemical reaction with another compound present in an environment where the structural material is installed may be supplied from a supplying source installed inside or around the structural material. For example, a supplying source that supplies zinc ions may be installed in a structural material constituting a structure constructed underground at a site near a volcano, and a coat of zinc sulfide produced by reaction with hydrogen sulfide present in the surroundings may be formed on the surface of the structural material.

An overview of one aspect of the present disclosure is as follows. A structural material according to one aspect of the present disclosure includes a base material for forming a structure and an ion supplying source provided inside or on a surface of the base material. The ion supplying source supplies at least one of a cation or an anion that constitutes a sparingly soluble salt having a water-solubility of no greater than a first value at a temperature of an environment where the base material is installed. This aspect makes it possible to form a surface layer of a sparingly soluble salt on the surface of the base material from the ions supplied from the ion supplying source. This can help improve the strength and the durability of the structural material.

The ion supplying source may include an ion-exchange resin having adsorbed thereto at least one of the cation or the anion. This aspect makes it possible to design appropriately the amount of ions supplied, the rate at which the ions are supplied, and so on.

The ion supplying source may include a capsule. The capsule may encapsulate a readily soluble salt or an ion-exchange resin. The readily soluble salt may include one of the cation or the anion and have a water-solubility of greater than the first value at a temperature of an environment where the base material is installed. The ion-exchange resin may include at least one of the cation or the anion. This aspect makes it possible to design appropriately the amount of ions supplied, the rate at which the ions are supplied, and so on.

The ion supplying source may include a sheet. The sheet may include a readily soluble salt or an ion-exchange resin. The readily soluble salt may include one of the cation or the anion and have a water-solubility of greater than the first value at a temperature of an environment where the base material is installed. The ion-exchange resin may include at least one of the cation or the anion. This aspect makes it possible to design appropriately the amount of ions supplied, the rate at which the ions are supplied, and so on.

The first value may be the value of the solubility of a compound that is a main component of the base material. This aspect makes it possible to form, on the surface of the base material, a surface layer of a sparingly soluble salt that is more sparingly soluble than the main component of the base material. This can help improve the strength and the durability of the structural material.

The sparingly soluble salt may be calcium carbonate. This aspect can help improve the strength and the durability of the structural material containing concrete, cement, or the like as the base material.

The base material may include a sparingly soluble compound having a water-solubility of no greater than a second value greater than the first value at a temperature of an environment where the base material is installed. The sparingly soluble compound may include an ion of a type identical to that of at least one of the cation or the anion that constitutes the sparingly soluble salt. This aspect makes it possible to keep the strength of the structural material from decreasing by keeping the sparingly soluble compound constituting the base material from eluting out.

The sparingly soluble salt and the sparingly soluble compound may be a sparingly soluble salt of calcium. The sparingly soluble salt may be calcium carbonate, and the sparingly soluble compound may be calcium hydroxide, calcium oxide, or calcium sulfate. This aspect can help improve the strength and the durability of the structural material containing concrete, cement, or the like as the base material.

A pore space inside the structural material may be filled with the sparingly soluble salt. This aspect can help improve the strength of the structural material.

A surface layer that includes the sparingly soluble salt may be formed on a surface of the structural material or the base material. This aspect can help improve the strength and the durability of the structural material.

The ion supplying source may be configured to supply a cation or an anion in an amount that allows a surface layer of a predetermined thickness to be formed on a surface of the structural material or the base material. This aspect can help improve the strength and the durability of the structural material.

The ion supplying source may be configured to supply a cation or an anion in an amount that allows a surface layer of a predetermined thickness to be formed on a surface of the structural material or the base material in accordance with the diffusion coefficient of the cation or the anion surrounding the structural material or the base material. This aspect makes it possible to control appropriately the thickness of the surface layer formed on the surface of the structural material in accordance with the environment where the structural material is installed.

A crack or a pore space produced in the surface layer after the surface layer has been formed may be self-repaired by the sparingly soluble salt. This aspect can help improve the strength and the durability of the structural material.

Another aspect of the present disclosure provides also a structural material. This structural material includes a base material for forming a structure and a surface layer formed on a surface of the base material. The surface layer includes a sparingly soluble salt having a water-solubility of no greater than a first value at a temperature of an environment where the base material is installed. This aspect can help improve the strength and the durability of the structural material.

The base material may include a sparingly soluble compound having a water-solubility of no greater than a second value greater than the first value at a temperature of an environment where the base material is installed. The sparingly soluble compound may include an ion of a type identical to that of at least one of a cation or an anion that constitutes the sparingly soluble salt. This aspect makes it possible to keep the strength of the structural material from decreasing by keeping the sparingly soluble compound constituting the base material from eluting out.

The sparingly soluble compound may be calcium hydroxide, calcium oxide, or calcium sulfate. This aspect can help improve the strength and the durability of the structural material containing concrete, cement, or the like as the base material.

Yet another aspect of the present disclosure provides a structure. This structure includes a foundation and a framework in contact with the foundation. At least one of the foundation or the framework includes a structural material. The structural material includes a base material for forming a structure. A sparingly soluble salt having a water-solubility of no greater than a predetermined value at a temperature of an environment where the base material is installed is formed on a surface of the base material or in a pore space inside or around the base material. This aspect can help improve the strength and the durability of the structure.

The structure may close off a hollow space drilled underground. The structure may constitute a wall of a space formed underground. A pore space or a crack in the ground surrounding the structure may be closed off by the sparingly soluble salt. This aspect can help improve the strength of the stratum or the bedrock surrounding the structure and can help improve the strength and the durability of the structure.

The structure may be installed underwater or outdoors. This aspect can help improve the strength and the durability of the structure.

Yet another aspect of the present disclosure provides a method of constructing a structure. This method is for constructing a structure of a structural material. The method includes installing a base material and providing an ion supplying source inside or on a surface of the base material. This aspect can help improve the strength and the durability of the structure.

The providing of the ion supplying source may include incorporating the ion supplying source into the base material, and the incorporating of the ion supplying source may be performed before the installing of the base material. This aspect can help improve the strength and the durability of the structure through a simple technique.

The structure may constitute a wall of a space formed underground. The providing of the ion supplying source may include forming a layer that includes the ion supplying source on a surface of bedrock or a stratum surrounding the space where the base material is installed, and the forming of the layer may be performed before the installing of the base material. This aspect can help improve the strength and the durability of the underground structure through a simple technique.

The structure may constitute a wall of a space formed underground. The providing of the ion supplying source may include injecting the ion supplying source between the base material and the bedrock or the stratum surrounding the space or into the structural material, and the injecting of the ion supplying source may be performed after the installing of the base material. This aspect can help improve the strength and the durability of the underground structure through a simple technique.

The method of constructing a structure may further include acquiring information concerning a constitution of a substance or a mineral that exists presently or that is expected to exist in the future at or around a location where the base material is installed. The ion supplying source of a type or an amount corresponding to the constitution of the substance or the mineral may be provided in the providing of the ion supplying source. This aspect makes it possible to produce a sparingly soluble salt of an appropriate type in accordance with the environment surrounding the structure and can thus help improve the strength and the durability of the structure.

Yet another aspect of the present disclosure provides a method of constructing a structure. This method is for constructing a structure of the structural material described above. The method includes installing a base material and forming a surface layer that includes a sparingly soluble salt on a surface of the base material. This aspect can help improve the strength and the durability of the structure.

The forming of the surface layer may include coating or spraying the surface of the installed base material with a first liquid including a cation that constitutes the sparingly soluble salt and a second liquid including an anion that constitutes the sparingly soluble salt. This aspect can help improve the strength and the durability of the structure through a simple technique.

The structure may constitute a wall of a space formed underground. The forming of the surface layer may include coating or spraying a surface of bedrock or a stratum surrounding the space where the base material is installed with a first liquid including a cation that constitutes the sparingly soluble salt and a second liquid including an anion that constitutes the sparingly soluble salt, and the coating or the spraying of the surface may be performed before the installing of the base material. This aspect can help improve the strength and the durability of the underground structure through a simple technique.

The method of constructing a structure may further include acquiring information concerning a constitution of a substance or a mineral that exists presently or that is expected to exist in the future at or around a location where the base material is installed. A surface layer that includes a sparingly soluble salt of a type corresponding to the constitution of the substance or the mineral may be formed in the forming of the surface layer. This aspect makes it possible to form a surface layer that includes a sparingly soluble salt of an appropriate type in accordance with the environment surrounding the structure and can thus help improve the strength and the durability of the structure.

Yet another aspect of the present disclosure provides a composition for sealing. This composition for sealing forms a surface layer on a surface of a base material for forming a structure or fills or closes off a pore space or a crack inside or outside the base material. The composition for sealing includes a cation or an anion that can constitute a sparingly soluble salt having a water-solubility of no greater than a predetermined value at a temperature of an environment where the composition for sealing is installed and an ion-exchange resin having adsorbed thereto at least one of the cation or the anion. This aspect can help improve the strength and the durability of a structural material and of a structure constructed of the structural material.

Yet another aspect of the present disclosure provides a composition for sealing. This composition for sealing forms a surface layer on a surface of a base material for forming a structure or fills or closes off a pore space or a crack inside or outside the base material. The composition for sealing includes a cation or an anion that can constitute a sparingly soluble salt having a water-solubility of no greater than a predetermined value at a temperature of an environment where the composition for sealing is installed and a counterion that can constitute, with the cation or the anion, a readily soluble salt having a water-solubility of greater than the predetermined value at a temperature of an environment where the composition for sealing is installed. This aspect can help improve the strength and the durability of a structural material and of a structure constructed of the structural material.

Yet another aspect of the present disclosure provides a composition for sealing. This composition for sealing forms a surface layer on a surface of a base material for forming a structure or fills or closes off a pore space or a crack inside or outside the base material. The composition for sealing includes a sparingly soluble salt having a water-solubility of no greater than a predetermined value at a temperature of an environment where the composition for sealing is installed. This aspect can help improve the strength and the durability of a structural material and of a structure constructed of the structural material.

The sparingly soluble salt may be calcium carbonate. This aspect makes it possible to provide a safe and inexpensive composition for sealing.

Yet another aspect of the present disclosure provides a method of using a composition for sealing. This method includes using a composition for sealing that includes a cation or an anion that can constitute a sparingly soluble salt having a water-solubility of no greater than a predetermined value at a temperature of an environment where the composition for sealing is installed and a counterion that can constitute, with the cation or the anion, a readily soluble salt having a water-solubility of greater than the predetermined value at a temperature of an environment where the composition for sealing is installed for the purpose of forming a surface layer on a surface of a base material for forming a structure or filling or closing off a pore space or a crack inside or outside the base material. This aspect can help improve the strength and the durability of a structural material and of a structure constructed of the structural material.

Yet another aspect of the present disclosure provides a composition for sealing. This composition for sealing forms a surface layer on a surface of a base material for forming a structure or fills or closes off a pore space or a crack inside or outside the base material. The composition for sealing includes a sparingly soluble salt having a water-solubility of no greater than a predetermined value at a temperature of an environment where the composition for sealing is installed. This aspect can help improve the strength and the durability of a structural material and of a structure constructed of the structural material.

Yet another aspect of the present disclosure provides a method of using a composition for sealing. This method includes using a composition for sealing that includes a sparingly soluble salt having a water-solubility of no greater than a predetermined value at a temperature of an environment where the composition for sealing is installed for the purpose of forming a surface layer on a surface of a base material for forming a structure or filling or closing off a pore space or a crack inside or outside the base material. This aspect can help improve the strength and the durability of a structural material and of a structure constructed of the structural material.

The sparingly soluble salt may be calcium carbonate. This aspect makes it possible to provide a safe and inexpensive composition for sealing.

Yet another aspect of the present disclosure provides an ion supplying material. This ion supplying material supplies at least one of a cation or an anion that constitutes a sparingly soluble salt having a water-solubility of no greater than a predetermined value at a temperature of an environment where the ion supplying material is installed. This ion supplying material includes an ion-exchange resin that includes at least one of the cation or the anion that constitutes the sparingly soluble salt, a capsule that encapsulates the ion-exchange resin or a readily soluble salt including one of the cation or the anion and having a water-solubility of greater than a predetermined value at a temperature of an environment where the ion supplying material is installed, or a sheet that includes the readily soluble salt or the ion-exchange resin. This aspect can help improve the strength and the durability of a structural material and of a structure constructed of the structural material.

### INDUSTRIAL APPLICABILITY

The present disclosure relates to structural materials and relates in particular to a structural material for constructing a structure, a structure constructed of the structural material, a method of constructing the structure, a composition for sealing that can be used in the structure, and an ion supplying material that can be used in the structural material.

### DESCRIPTION OF THE REFERENCE NUMERALS

10 boring hole, 12 crack, 14 space, 16 bedrock, 20 structural material, 21 base material, 22 ion supplying source, 30 sparingly soluble salt, 40 structure, 41 foundation, 42 framework

1-27. (canceled)

28. A structural material, comprising:
a base material for forming a structure; and
an ion supplying source that supplies a bicarbonate ion,
the ion supplying source including at least one of an ion-exchange resin having adsorbed thereto a bicarbonate ion, a capsule encapsulating and releasing gradually an ion-exchange resin having adsorbed thereto bicarbonate or a bicarbonate ion, or a sheet including an ion-exchange resin having adsorbed thereto bicarbonate or a bicarbonate ion.

29. The structural material according to claim 28, wherein
the ion supplying source further includes at least one of an ion-exchange resin having adsorbed thereto an iron ion, a capsule encapsulating and releasing gradually an ion-exchange resin having adsorbed thereto an iron salt or an iron ion, or a sheet including an ion-exchange resin having adsorbed thereto an iron salt or an iron ion.

30. A structural material, comprising:
a base material for forming a structure; and
an ion supplying source that supplies an iron ion,
the ion supplying source including at least one of an ion-exchange resin having adsorbed thereto an iron ion, a capsule encapsulating and releasing gradually an ion-exchange resin having adsorbed thereto an iron salt or an iron ion, or a sheet including an ion-exchange resin having adsorbed thereto an iron salt or an iron ion.

31. A structural material, comprising:
a base material for forming a structure; and
an ion supplying source that supplies an iron ion for precipitating iron hydroxide on a surface of the base material or in a pore space around the base material upon a rise in pH in the surroundings of the base material.

32. The structural material according to claim 28, wherein
a pore space produced in a contact part between the structural material and a surrounding ground thereof is filled with a sparingly soluble substance generated from an ion supplied from the ion supplying source.

33. The structural material according to claim 29, wherein
a pore space produced in a contact part between the structural material and a surrounding ground thereof is filled with a sparingly soluble substance generated from an ion supplied from the ion supplying source.

34. The structural material according to claim 30, wherein
a pore space produced in a contact part between the structural material and a surrounding ground thereof is filled with a sparingly soluble substance generated from an ion supplied from the ion supplying source.

35. The structural material according to claim 31, wherein
a pore space produced in a contact part between the structural material and a surrounding ground thereof is filled with a sparingly soluble substance generated from an ion supplied from the ion supplying source.

36. The structural material according to claim 28, wherein
the structural material includes a surface layer that includes a sparingly soluble substance generated from an ion supplied from the ion supplying source.

37. The structural material according to claim 29, wherein
the structural material includes a surface layer that includes a sparingly soluble substance generated from an ion supplied from the ion supplying source.

38. The structural material according to claim 30, wherein
the structural material includes a surface layer that includes a sparingly soluble substance generated from an ion supplied from the ion supplying source.

39. The structural material according to claim 31, wherein
the structural material includes a surface layer that includes a sparingly soluble substance generated from an ion supplied from the ion supplying source.

40. The structural material according to claim 33, wherein
the structural material includes a surface layer that includes a sparingly soluble substance generated from an ion supplied from the ion supplying source.

41. The structural material according to claim 34, wherein
the structural material includes a surface layer that includes a sparingly soluble substance generated from an ion supplied from the ion supplying source.

42. The structural material according to claim 35, wherein
the structural material includes a surface layer that includes a sparingly soluble substance generated from an ion supplied from the ion supplying source.

43. The structural material according to claim 36, wherein
the structural material includes a surface layer that includes a sparingly soluble substance generated from an ion supplied from the ion supplying source.

44. The structural material according to claim 28, wherein
the base material includes a sparingly soluble compound composed of a cation constituting the sparingly soluble salt with a bicarbonate ion.

45. The structural material according to claim 29, wherein
the base material includes a sparingly soluble compound composed of a cation constituting the sparingly soluble salt with a bicarbonate ion.

46. The structural material according to claim 34, wherein
the sparingly soluble compound is calcium hydroxide or calcium sulfate.

47. The structural material according to claim 35, wherein
the sparingly soluble compound is calcium hydroxide or calcium sulfate.
